(19) United States
(12) Patent Application Publication
(10) Pub. No.: US 2024/0049286 A1
(43) Pub. Date: Feb. 8, 2024

(54) SL RESOURCE SELECTION AND RESELECTION FOR SL TRANSMISSION

(71) Applicant: Samsung Electronics Co., Ltd., Suwon-si (KR)

(72) Inventors: Kyeongin Jeong, Allen, TX (US); Hongbo Si, Plano, TX (US); Shiyang Leng, Allen, TX (US)

(21) Appl. No.: 18/358,753

(22) Filed: Jul. 25, 2023

Related U.S. Application Data
(60) Provisional application No. 63/395,247, filed on Aug. 4, 2022.
(60) Provisional application No. 63/428,951, filed on Nov. 30, 2022.

(51) Int. Cl. H04W 74/08; H04W 16/14

(52) U.S. Cl. CPC H04W 74/0816; H04W 16/14

(57) ABSTRACT

Methods and apparatuses for sidelink (SL) resource selection and reselection for a SL transmission in a wireless communication system. A method of operating a user equipment (UE) includes determining whether a sidelink (SL) unlicensed band is configured for a SL transmission and performing a channel sensing operation to determine whether a channel is available for channel access on the SL unlicensed band. The method further includes identifying a gap, based on a time duration for the channel sensing operation, for the SL transmission and selecting, based on the identified gap, a SL resource for the SL transmission. The SL resource is located outside of the identified gap from a previously reserved SL resource.

### CROSS-REFERENCE TO RELATED APPLICATIONS AND CLAIM OF PRIORITY

The present application claims priority to U.S. Provisional Patent Application No. 63/395,247, filed on Aug. 4, 2022; and U.S. Provisional Patent Application No. 63/428,951, filed on Nov. 30, 2022. The contents of the above-identified patent documents are incorporated herein by reference.

### TECHNICAL FIELD

The present disclosure relates generally to wireless communication systems and, more specifically, the present disclosure relates to sidelink (SL) resource selection and reselection for a SL transmission in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to SL resource selection and reselection for a SL transmission in a wireless communication system.

In one embodiment, a UE is provided. The UE includes a transceiver and a processor operably coupled to the transceiver, the processor configured to: determine whether a SL unlicensed band is configured for a SL transmission, perform a channel sensing operation to determine whether a channel is available for channel access on the SL unlicensed band, identify a gap, based on a time duration for the channel sensing operation, for the SL transmission, and select, based on the identified gap, a SL resource for the SL transmission, wherein the SL resource is located outside of the identified gap from a previously reserved SL resource.

In another embodiment, a UE is provided. The UE includes a transceiver and a processor operably coupled to the transceiver, the processor configured to: determine whether a SL unlicensed band is configured for SL transmissions, determine, based on a determination that the SL unlicensed band is configured, whether a physical (PHY) layer indication is triggered, wherein the PHY layer indication indicates a failure of a channel access operation for a previous SL transmission, and enable a medium access control (MAC) layer to trigger a SL resource selection or reselection procedure based on a determination that the PHY layer indication is triggered.

In yet another embodiment, a method of a UE is provided. The method comprises: determining whether a SL unlicensed band is configured for a SL transmission; performing a channel sensing operation to determine whether a channel is available for channel access on the SL unlicensed band; identifying a gap, based on a time duration for the channel sensing operation, for the SL transmission; and selecting, based on the identified gap, a SL resource for the SL transmission, wherein the SL resource is located outside of the identified gap from a previously reserved SL resource.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of V2X communication over SL according to embodiments of the present disclosure;

FIGS. 7A and 7B illustrate examples of SL control and user planes radio protocol stacks;

FIG. 8 illustrates an example of Type 1 DL/UL channel access procedure according to embodiments of the present disclosure;

FIG. 9 illustrates a signaling flow for SL resource (re)selection check and SL resource (re)selection according to embodiments of the present disclosure;

FIG. 10 illustrates a signaling flow for SL resource (re)selection according to embodiments of the present disclosure;

FIG. 11 illustrates a signaling flow for SL resource allocation using SL measurement according to embodiments of the present disclosure;

FIG. 12 illustrates an example of legacy time relations for candidate SL resources in PHY sub-layer according to embodiments of the present disclosure; and

FIG. 13 illustrates a flowchart of a method for a UE operation for SL resource selection and reselection for a SL transmission.

### DETAILED DESCRIPTION

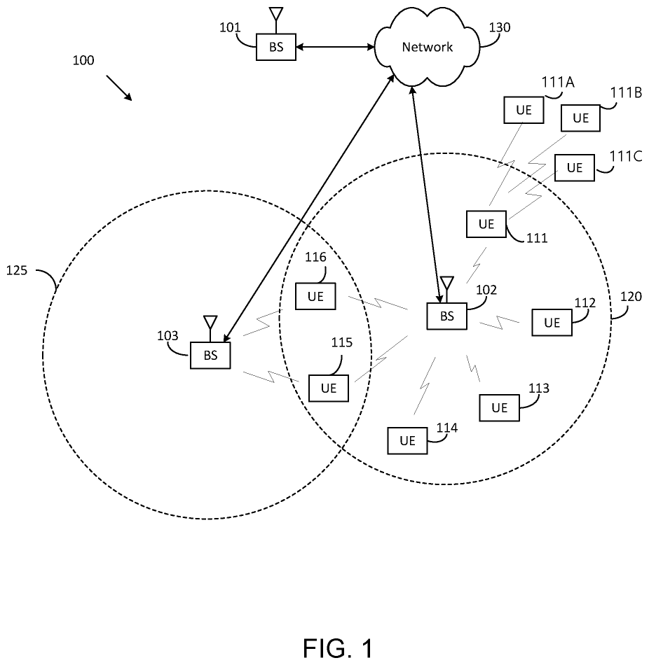

FIG. 1 through FIG. 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.6.0, “NR; Physical channels and modulation”; 3GPP TS 38.212 v16.6.0, “NR; Multiplexing and channel coding”; 3GPP TS 38.213 v16.6.0, “Physical Layer Procedures for Control”; 3GPP TS 38.214 v16.6.0, “Physical Layer Procedures for data”; 3GPP TS 38.321 v16.5.0, “Medium Access Control (MAC) protocol specification”; 3GPP TS 38.331 v16.5.0, “Radio Resource Control (RRC) protocol specification”; 3GPP TR 38.885 v16.0.0, “Study on NR Vehicle-to-Everything (V2X)”; and 3GPP TS 37.213 v16.6.0, “Physical layer procedures for shared spectrum channel access.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UE are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for SL resource selection and reselection for a SL transmission in a wireless communication system. In certain embodiments, and one or more of the gNBs 101-103 includes circuitry, programing, or a combination thereof, for supporting SL resource selection and reselection for a SL transmission in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

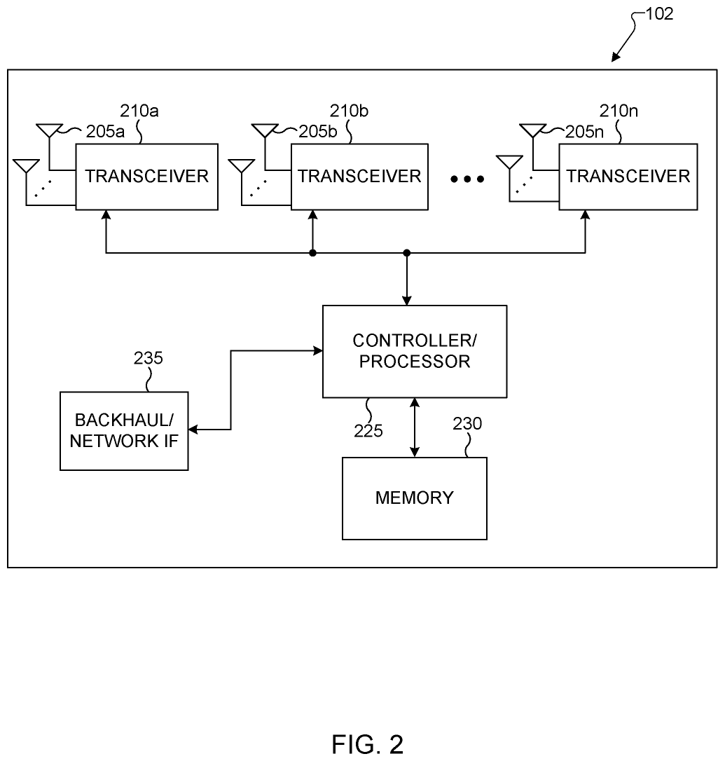

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes, for example, to support SL resource selection and reselection for a SL transmission in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

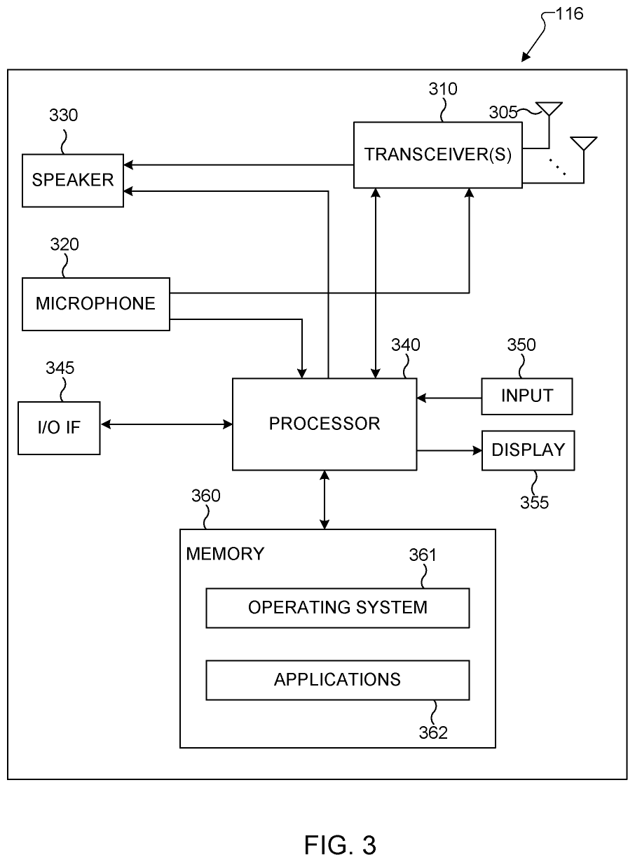

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL and/or SL channels and/or signals and the transmission of UL and/or SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for supporting SL resource selection and reselection for a SL transmission in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

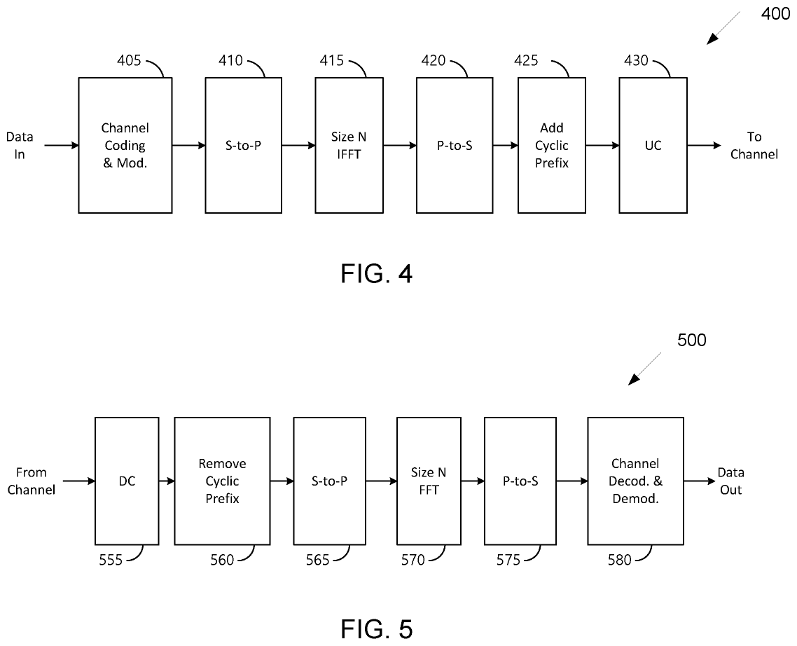

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. It may also be understood that the receive path 500 can be implemented in a first UE and that the transmit path 400 can be implemented in a second UE to support SL communications. In some embodiments, the receive path 500 is configured to support SL resource selection and reselection for a SL transmission in a wireless communication system as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a downconverter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. A transmitted RF signal from a first UE arrives at a second UE after passing through the wireless channel, and reverse operations to those at the first UE are performed at the second UE.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNB s 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and/or transmitting in the sidelink to another UE and may implement the receive path 500 for receiving in the downlink from the gNBs 101-103 and/or receiving in the sidelink from another UE.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In 3GPP wireless standards, new radio access technology (NR) has been specified as 5G wireless communication. One of NR features is vehicle-to-everything (V2X).

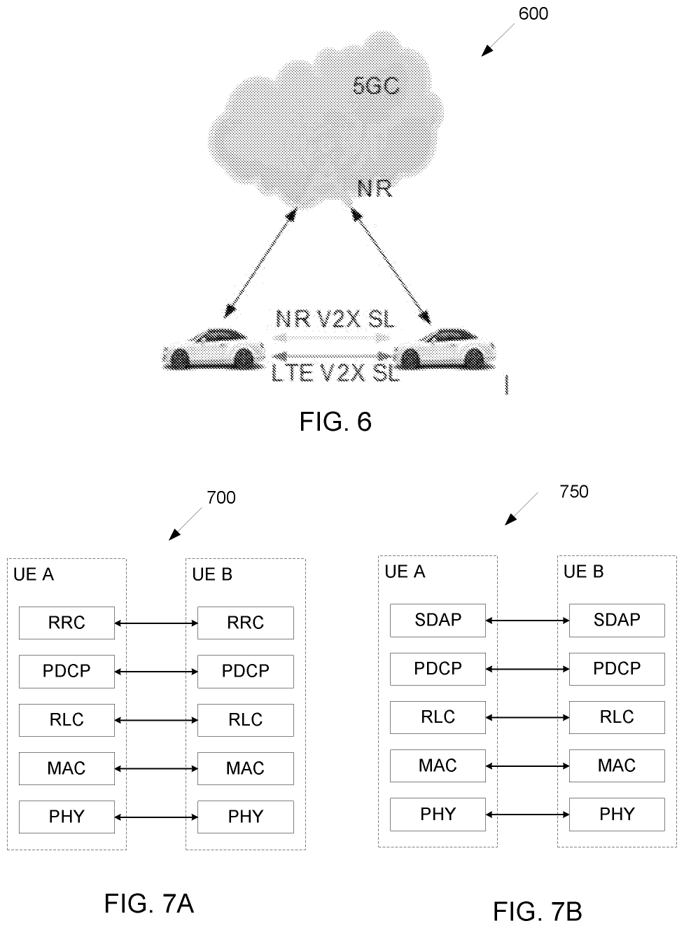

FIG. 6 illustrates an example of V2X communication over SL 600 according to embodiments of the present disclosure. An embodiment of the V2X communication over SL 600 shown in FIG. 6 is for illustration only.

FIG. 6 describes the example scenario of vehicle to vehicle communication. Two or multiple vehicles can transmit and receive data/control over direct link/interface between vehicles. The direct link/interface between vehicles or between vehicle and other things is named as SL in 3GPP, so “SL communication” is also commonly used instead of “V2X communication.”

Note that FIG. 6 describes the scenario where the vehicles still can communicate with a gNB in order to acquire SL resource, SL radio bearer configurations, etc., however it is also possible even without interaction with the gNB, vehicles still communicate each other over SL. In the case, SL resource, SL radio bearer configuration, etc. are preconfigured (e.g., via V2X server or any other core network entity).

One main difference compared to an uplink (UL) that is a link from the UE to the gNB is the resource allocation mechanism for transmission. In UL, the resource for transmission is allocated by the gNB, however in SL, the UE itself selects a resource within the SL resource pool, which is configured by the gNB and selected by the UE if multiple SL resource pools are configured, based on UE's channel sensing result and the required amount of resources for data/control transmission.

For SL communication, the radio interface L1/L2/L3 (Layer 1/Layer 2/Layer 3) protocols includes physical protocol (PHY), which specified in 3GPP standards TS 38.211, 38.212, 38.213, 38.214, and 38.215), medium access control (MAC), which specified in 3GPP standards TS 38.321), radio link control (RLC), which specified in 3GPP standards TS 38.322), packet data convergence protocol (PDCP), which specified in 3GPP standards TS 38.323), radio resource control (RRC), which specified in 3GPP standards TS 38.331, and service data adaptation protocol (SDAP), which specified in 3GPP standards TS 37.324).

FIGS. 7A and 7B illustrate examples of SL control and user planes radio protocol stack 700 according to embodiments of the present disclosure. An embodiment of the SL control and user planes radio protocol stack 700 shown in FIG. 7 is for illustration only.

FIG. 7A illustrates an example of a SL control plane radio protocol stack (for SL-RRC) and FIG. 7B illustrates an example of SL user plane data radio protocol stack for NR SL communication.

A physical protocol layer handles physical layer signals/channels and physical layer procedures (e.g., physical layer channel structure, physical layer signal encoding/decoding, SL power control procedure, SL cannel status information (CSI) related procedure).

Main physical SL channels and signals are defined as follow: (1) physical sidelink control channel (PSCCH) indicates resource and other transmission parameters used by a UE for PSSCH; (2) physical sidelink shared channel (PSSCH) transmits the TB s of data themselves and CSI feedback information, etc.; (3) physical sidelink feedback channel (PSFCH) transmits HARQ feedback over the sidelink from a UE which is an intended recipient of a PSSCH transmission to the UE which performed the transmission; (4) sidelink synchronization signal includes sidelink primary and sidelink secondary synchronization signals (S-PSS, S-SSS); and (5) physical sidelink broadcast channel (PSBCH) indicates the required essential system information for SL operations.

A MAC protocol layer performs packet filtering (e.g., determine whether the received packet is actually destined to the UE (based on the L2 source and destination ids in the MAC header), SL carrier/resource pool/resource within the resource pool (re)selection, priority handling between SL and UL for a given UE, SL logical channel prioritization, the corresponding packet multiplexing (e.g., multiplexing multiple MAC SDUs into a given MAC PDU) and SL HARQ retransmissions/receptions. An RLC protocol layer performs RLC SDU segmentation/SDU reassembly, re-segmentation of RLC SDU segments, error correction through ARQ (only for AM data transfer).

A PDCP protocol layer performs header compression/decompression, ciphering and/or integrity protection, duplication detection, re-ordering and in-order packet delivery to the upper layer and out-of-order packet delivery to the upper layer. An RRC protocol layer performs transfer of a SL-RRC message, which is also named as PC5-RRC (PC5 indicates the reference point between UEs for SL communication), between peer UEs, maintenance and release of SL-RRC connection between two UEs, and detection of SL radio link failure for a SL-RRC connection. A SDAP protocol layer performs mapping between a quality of service (QoS) flow and a SL data radio bearer. Note that the term of SL-RRC or PC5-RRC is used in the present disclosure.

Another NR features is NR on unlicensed spectrum (NR-U), which was introduced in Rel-16. A node (e.g., gNB or UE) can initialize a channel occupancy on an operating channel after performing a channel access procedure, wherein the channel access procedure includes at least one sensing slot and the sensing is based on energy detection. In particular, for a single carrier channel access with dynamic channel access (or load-based-equipment (LBE) mode), a gNB can initialize a channel occupancy after performing the Type 1 DL channel access procedure, and a UE can initialize a channel occupancy after performing the Type 1 UL channel access procedure.

In the Type 1 DL/UL channel access procedure, the time duration spanned by the sensing slots that are sensed to be idle before a transmission is random, and the time duration include a first period (e.g., initial CCA period) including a duration of 16 us and a fixed number (e.g., mₚ) of sensing slots, and a second period (e.g., extended CCA period) including a random number (e.g., N) of sensing slots, wherein mₚ is determined based on the channel access priority class (CAPC) p, and a length of the sensing slot is 9 us, for 5 GHz and 6 GHz unlicensed spectrum.

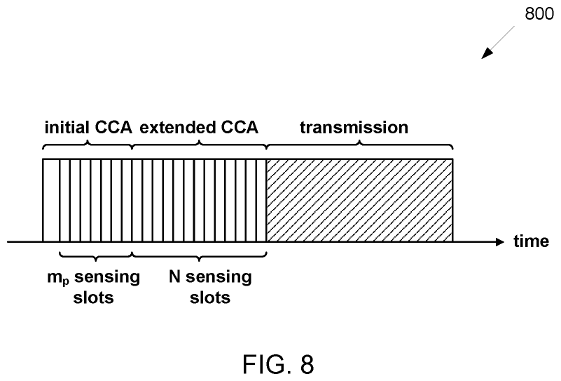

FIG. 8 illustrate an example of Type 1 DL/UL channel access procedure 800 according to embodiments of the present disclosure. An embodiment of the Type 1 DL/UL channel access procedure 800 shown in FIG. 8 is for illustration only.

The random number N is an integer generated uniformly between 0 and CWₚ, and CWₚ is adjusted between a minimum value CW_{min,p} and a maximum value CW_{max,p}, according to the CAPC as well. After the Type 1 DL/UL channel access procedure, the node can occupy the channel for a maximum duration T_{mcot,p}, which is also based on the CAPC. In Rel-16 NR-U, 4 CAPCs are supported, and the mapping between CAPC (e.g., p) and its associated mₚ, CW_{min,p}, CW_{max,p}, T_{mcot,p}, and allowed values of CWₚ for DL and UL transmissions are shown in FIG. 8. TABLE 1C below shows which CAPC may be used for which standardized 5QIs i.e., which CAPC to use for a given QoS flow.

TABLE 1A
Channel access priority class for DL

| CAPC | | | | T_{mcot,p} | |
|---|---|---|---|---|---|
| (p) | mₚ | CW_{min,p} | CW_{max,p} | (ms) | allowed CWₚ |
| 1 | 1 | 3 | 7 | 2 | {3, 7} |
| 2 | 1 | 7 | 15 | 3 | {7, 15} |
| 3 | 3 | 15 | 63 | 8 or 10 | {15, 31, 63} |
| 4 | 7 | 15 | 1023 | 8 or 10 | {15, 31, 63, 127, 255, |
| | | | | | 511, 1023} |

TABLE 1B
Channel access priority class for UL

| CAPC | | | | T_{mcot,p} | |
|---|---|---|---|---|---|
| (p) | mₚ | CW_{min,p} | CW_{max,p} | (ms) | allowed CWₚ |
| 1 | 1 | 3 | 7 | 2 | {3, 7} |
| 2 | 1 | 7 | 15 | 3 | {7, 15} |
| 3 | 3 | 15 | 1023 | 6 or 10 | {15, 31, 63, 127, 255, |
| | | | | | 511, 1023} |
| 4 | 7 | 15 | 1023 | 6 or 10 | {15, 31, 63, 127, 255, |
| | | | | | 511, 1023} |

TABLE 1C
Mapping between channel access priority classes and 5QI

| CAPC | 5QI |
|---|---|
| 1 | 1, 3, 5, 65, 66, 67, 69, 70, 79, 80, 82, 83, 84, 85 |
| 2 | 2, 7, 71 |
| 3 | 4, 6, 8, 9, 72, 73, 74, 76 |
| 4 | — |

NOTE:
lower CAPC value means higher priority

In 3GPP Rel-18, it is planned to introduce more enhanced features into SL communication and one of the candidate features is to enable SL communication in unlicensed band that can be shared with other radio access technology (RAT), e.g., WiFi, Bluetooth, etc. The present disclosure provides the enhanced resource (re)selection procedure for a SL transmission in unlicensed band.

In a SL communication, a PHY sub-layer indicates the candidate resources based on SL sensing (for resource allocation purpose) to a MAC sub-layer and MAC (re)selects (a) transmission (TX) resource(s) among the candidate resources when it has data to be transmitted. MAC specifies the conditions when triggers MAC performs TX resource (re)selection on the selected TX pool as follows (checking whether the conditions are met or not is called as TX resource (re)selection check procedure). TABLE 2 shoes the TX resource (re)selection check process.

TABLE 2
TX resource (re)selection check

```
            5.22.1.2 TX resource (re-)selection check
If the TX resource (re-)selection check procedure is triggered on the selected pool of resources
for a Sidelink process according to clause 5.22.1.1 in 3GPP standard specification, the MAC
entity shall for the Sidelink process:
  1> if PSCCH duration(s) and 2^{nd} stage SCI on PSSCH for all transmissions of a MAC PDU
      of any selected sidelink grant(s) are not in SL DRX Active time as specified in clause
      5.28.3 in 3GPP standard specification of the destination that has data to be sent; or
  1> if SL_RESOURCE_RESELECTION_COUNTER = 0 and when
      SL_RESOURCE_RESELECTION_COUNTER was equal to 1 the MAC entity randomly
      selected, with equal probability, a value in the interval [0, 1] which is above the probability
      configured by RRC in sl-ProbResourceKeep; or
  1> if the pool of resources is configured or reconfigured by RRC; or
  1> if there is no selected sidelink grant on the selected pool of resources; or
  1> if neither transmission nor retransmission has been performed by the MAC entity on any
      resource indicated in the selected sidelink grant during the last second; or
  1> if sl-ReselectAfter is configured and the number of consecutive unused transmission
      opportunities on resources indicated in the selected sidelink grant, which is incremented
      by 1 when none of the resources of the selected sidelink grant within a resource reservation
      interval is used, is equal to sl-ReselectAfter; or
  1> if the selected sidelink grant cannot accommodate a RLC SDU by using the maximum
      allowed MCS configured by RRC in sl-MaxMCS-PSSCH associated with the selected
      MCS table and the UE selects not to segment the RLC SDU; or
  NOTE 1: If the selected sidelink grant cannot accommodate the RLC SDU, it is left for
        UE implementation whether to perform segmentation or sidelink resource
        reselection.
  1> if transmission(s) with the selected sidelink grant cannot fulfil the remaining PDB of the
      data in a logical channel, and the MAC entity selects not to perform transmission(s)
      corresponding to a single MAC PDU:
  NOTE 2: If the remaining PDB is not met, it is left for UE implementation whether to
        perform transmission(s) corresponding to single MAC PDU or sidelink resource
        reselection.
  NOTE 3: It is left for UE implementation whether to trigger the TX resource (re-)
        selection due to the latency requirement of the MAC CE triggered according to
        clause 5.22.1.7 in 3GPP standard specification.
    2> clear the selected sidelink grant associated to the Sidelink process, if available;
    2> trigger the TX resource (re-)selection.
```

When TX resource (re)selection is triggered as the result of TX resource (re)selection check procedure, how MAC performs TX resource (re)selection is specified as shown in TABLE 3.

TABLE 3
MAC TX resource (re)selection

```
If the MAC entity has been configured with Sidelink resource allocation mode 2 to transmit
using pool(s) of resources in a carrier as indicated in 3GPP standard specification based on full
sensing, or partial sensing, or random selection or any combination(s), the MAC entity shall for
each Sidelink process:
  NOTE 1: If the MAC entity is configured with Sidelink resource allocation mode 2 to
    transmit using a pool of resources in a carrier as indicated in 3GPP standard
    specification, the MAC entity can create a selected sidelink grant on the pool of
    resources based on random selection, or partial sensing, or full sensing only after
    releasing configured sidelink grant(s), if any.
  NOTE 2: The MAC entity expects that PSFCH is configured by RRC for at least one
    pool of resources in sl-TxPoolSelectedNormal and for the resource pool in sl-
    TxPoolExceptional in case that at least a logical channel configured with sl-
    HARQ-FeedbackEnabled is set to enabled.
1> if the MAC entity has selected to create a selected sidelink grant corresponding to
  transmissions of multiple MAC PDUs, and SL data is available in a logical channel:
  2> if the MAC entity has not selected a pool of resources allowed for the logical channel:
    3> if SL data is available in the logical channel for sidelink discovery:
      4> if sl-BWP-DiscPoolConfig or sl-BWP-DiscPoolConfigCommon is configured
        according to 3GPP standard specification:
        5> select the sl-DiscTxPoolSelected configured in sl-BWP-DiscPoolConfig or
          sl-BWP-DiscPoolConfigCommon for the transmission of sidelink discovery
          message.
      4> else:
        5> select any pool of resources among the configured pools of resources.
    3> else if sl-HARQ-FeedbackEnabled is set to enabled for the logical channel:
      4> select any pool of resources configured with PSFCH resources among the pools
        of resources except the pool(s) in sl-BWP-DiscPoolConfig or sl-BWP-
        DiscPoolConfigCommon, if configured.
    3> else:
      4> select any pool of resources among the pools of resources except the pool(s) in
        sl-BWP-DiscPoolConfig or sl-BWP-DiscPoolConfigCommon, if configured.
  2> perform the TX resource (re-)selection check on the selected pool of resources as
    specified in clause 5.22.1.2 in 3GPP standard specification;
NOTE 3: The MAC entity continuously performs the TX resource (re-)selection check
      until the corresponding pool of resources is released by RRC, or the MAC entity
      decides to cancel creating a selected sidelink grant corresponding to transmissions
      of multiple MAC PDUs.
  2> if the TX resource (re-)selection is triggered as the result of the TX resource (re-)selection
    check:
    3> if one or multiple SL DRX is configured in the destination UE(s) receiving SL-
      SCH data:
      4> indicate to the physical layer SL DRX Active time in the destination UE(s)
        receiving SL-SCH data, as specified in clause 5.28.2 in 3GPP standard
        specification.
    3> select one of the allowed values configured by RRC in sl-
      ResourceReservePeriodList and set the resource reservation interval, Prsvp TX, with
      the selected value;
NOTE 3A: The MAC entity selects a value for the resource reservation interval which is
      larger than the remaining PDB of SL data available in the logical channel.
    3> randomly select, with equal probability, an integer value in the interval [5, 15] for
      the resource reservation interval higher than or equal to 100ms or in the interval
      $[ 5 \times ⌈ \frac{100}{max ( 20 , {P}_{rsvp \_ TX} )} ⌉ , 15 \times ⌈ \frac{100}{max ( 20 , {P}_{rsvp \_ TX} )} ⌉ ]$
      for the resource reservation interval lower than 100ms and set
      SL_RESOURCE_RESELECTION_COUNTER to the selected value;
    3> select the number of HARQ retransmissions from the allowed numbers, if
      configured by RRC, in sl-MaxTxTransNumPSSCH included in sl-PSSCH-
      TxConfigList and, if configured by RRC, overlapped in sl-
      MaxTxTransNumPSSCH indicated in sl-CBR-PriorityTxConfigList for the highest
      priority of the logical channel(s) allowed on the carrier and the CBR measured by
      lower layers if CBR measurement results are available or the corresponding sl-
      defaultTxConfigIndex configured by RRC if CBR measurement results are not available;
    3> select an amount of frequency resources within the range, if configured by RRC,
        between sl-MinSubChannelNumPSSCH and sl-MaxSubchannelNumPSSCH
        included in sl-PSSCH-TxConfigList and, if configured by RRC, overlapped
        between MinSubChannelNumPSSCH and MaxSubchannelNumPSSCH indicated in
        sl-CBR-PriorityTxConfigList for the highest priority of the logical channel(s)
        allowed on the carrier and the CBR measured by lower layers if CBR
        measurement results are available or the corresponding sl-defaultTxConfigIndex
        configured by RRC if CBR measurement results are not available;
    3> if not configured by RRC, sl-InterUE-CoordinationScheme1 enabling reception of
        preferred resource set and non-preferred resource set:
      4> if transmission based on random selection is configured by upper layers:
        5> randomly select the time and frequency resources for one transmission
          opportunity from the resource pool which occur within the SL DRX Active
          time as specified in clause 5.28.2 in 3GPP standard specification of the
          destination UE selected for indicating to the physical layer the SL DRX
          Active time above, according to the amount of selected frequency resources
          and the remaining PDB of SL data available in the logical channel(s)
          allowed on the carrier;
          5> if selected resource for initial transmission occasion is not in the SL DRX
            Active time as specified in clause 5.28.3 in 3GPP standard specification of
            any destination that has data to be sent:
          6> use retransmission occasion(s) for initial transmission of PSCCH and PSSCH.
      4> else:
        5> randomly select the time and frequency resources for one transmission
          opportunity from the resources indicated by the physical layer as specified in
          clause 8.1.4 in 3GPP standard specification which occur within the SL DRX
          Active time as specified in clause 5.28.2 in 3GPP standard specification of
          the destination UE selected for indicating to the physical layer the SL DRX
          Active time above, according to the amount of selected frequency resources
          and the remaining PDB of SL data available in the logical channel(s)
          allowed on the carrier;
        5> if selected resource for initial transmission occasion is not in the SL DRX
          Active time as specified in clause 5.28.3 in 3GPP standard specification of
          any destination that has data to be sent:
          6> use retransmission occasion(s) for initial transmission of PSCCH and PSSCH.
    3> if configured by RRC, sl-InterUE-CoordinationScheme1enabling reception of
      preferred resource set and non-preferred resource set and neither preferred
      resource set nor non-preferred resource set is received from a UE:
      4> if transmission based on random selection is configured by upper layers:
        5> randomly select the time and frequency resources for one transmission
          opportunity from the resources pool, according to the amount of selected
          frequency resources and the remaining PDB of SL data available in the
          logical channel(s) allowed on the carrier.
      4> else:
        5> randomly select the time and frequency resources for one transmission
          opportunity from the resources indicated by the physical layer as specified in
          clause 8.1.4 in 3GPP standard specification, according to the amount of
          selected frequency resources and the remaining PDB of SL data available in
          the logical channel(s) allowed on the carrier.
      3> if configured by RRC, sl-InterUE-CoordinationScheme1 enabling reception of
        preferred resource set and non-preferred resource set and when the UE does not
        have own sensing result as specified in clause 8.1.4 in 3GPP standard specification
        and if a preferred resource set is received from a UE:
        4> randomly select the time and frequency resources for one transmission
          opportunity from the resources belonging to the received preferred resource set
          for a MAC PDU to be transmitted to the UE providing the preferred resource
          set, according to the amount of selected frequency resources and the remaining
          PDB of SL data available in the logical channel(s) allowed on the carrier.
      3> if configured by RRC, sl-InterUE-CoordinationScheme1 enabling reception of
        preferred resource set and non-preferred resource set and when the UE has own
        sensing result as specified in clause 8.1.4 in 3GPP standard specification and if a
        preferred resource set is received from a UE:
        4> randomly select the time and frequency resources for one transmission
          opportunity within the intersection of the received preferred resource set and the
          resources indicated by the physical layer as specified in clause 8.1.4 in 3GPP
          standard specification for a MAC PDU to be transmitted to the UE providing
          the preferred resource set, according to the amount of selected frequency
          resources and the remaining PDB of SL data available in the logical channel(s)
          allowed on the carrier.
        4> if there are no resources within the intersection that can be selected as the time
          and frequency resources for the one transmission opportunity according to the
          amount of selected frequency resources and the remaining PDB of SL data
          available in the logical channel(s) allowed on the carrier.
          5> randomly select the time and frequency resources for one transmission
            opportunity from the resources indicated by the physical layer as specified in
            clause 8.1.4 in 3GPP standard specification, according to the amount of
            selected frequency resources and the remaining PDB of SL data available in
            the logical channel(s) allowed on the carrier.
        4> use the randomly selected resource to select a set of periodic resources spaced
          by the resource reservation interval for transmissions of PSCCH and PSSCH
          corresponding to the number of transmission opportunities of MAC PDUs
          determined in 3GPP standard specification.
      3> if configured by RRC, sl-InterUE-CoordinationScheme1 enabling reception of
        preferred resource set and non-preferred resource set and when the UE has own
        sensing result as specified in clause 8.1.4 in 3GPP standard specification and if a
        non-preferred resource set is received from a UE:
        4> indicate the received non-preferred resource set to the physical layer.
      3> if one or more HARQ retransmissions are selected:
        4> if not configured by RRC, sl-InterUE-CoordinationScheme1 enabling reception
          of preferred resource set and non-preferred resource set:
          5> if transmission based on full sensing or partial sensing is configured by
            upper layers and there are available resources left in the resources indicated
            by the physical layer according to clause 8.1.4 in 3GPP standard
            specification for more transmission opportunities; or
          5> if transmission based on random selection is configured by upper layers and
            there are available resources left in the resource pool for more transmission
            opportunities:
            6> randomly select the time and frequency resources for one or more
              transmission opportunities from the available resources which occur
              within the SL DRX Active time as specified in clause 5.28.2 in 3GPP
              standard specification of the destination UE selected for indicating to the
              physical layer the SL DRX Active time above, according to the amount of
              selected frequency resources, the selected number of HARQ
              retransmissions and the remaining PDB of SL data available in the logical
              channel(s) allowed on the carrier by ensuring the minimum time gap
              between any two selected resources in case that PSFCH is configured for
              this pool of resources and that a retransmission resource can be indicated
              by the time resource assignment of a prior SCI according to clause 8.3.1.1
              in 3GPP standard specification.
      4> if configured by RRC, sl-InterUE-CoordinationScheme1 enabling reception of
        preferred resource set and non-preferred resource set and neither preferred
        resource set nor non-preferred resource set is received from a UE:
          5> if transmission based on full sensing or partial sensing is configured by
            upper layers and there are available resources left in the resources indicated
            by the physical layer according to clause 8.1.4 in 3GPP standard
            specification for more transmission opportunities; or
          5> if transmission based on random selection is configured by upper layers and
            there are available resources left in the resource pool for more transmission
            opportunities:
            6> randomly select the time and frequency resources for one or more
              transmission opportunities from the available resources, according to the
              amount of selected frequency resources, the selected number of HARQ
              retransmissions and the remaining PDB of SL data available in the logical
              channel(s) allowed on the carrier by ensuring the minimum time gap
              between any two selected resources in case that PSFCH is configured for
              this pool of resources and that a retransmission resource can be indicated
              by the time resource assignment of a prior SCI according to clause 8.3.1.1
              in 3GPP standard specification.
      4> if configured by RRC, sl-InterUE-CoordinationScheme1 enabling reception of
        preferred resource set and non-preferred resource set and when the UE has own
        sensing result as specified in clause 8.1.4 in 3GPP standard specification and if
        a preferred resource set is received from a UE; and
      4> if there are available resources left in the intersection of the received preferred
        resource set and the resources indicated by the physical layer as specified in
        clause 8.1.4 in 3GPP standard specification for more transmission
        opportunities:
      5> randomly select the time and frequency resources for one or more
        transmission opportunities from the available resources within the
        intersection for a MAC PDU to be transmitted to the UE providing the
        preferred resource set, according to the amount of selected frequency
        resources, the selected number of HARQ retransmissions and the remaining
        PDB of SL data available in the logical channel(s) allowed on the carrier by
        ensuring the minimum time gap between any two selected resources in case
        that PSFCH is configured for this pool of resources and that a retransmission
        resource can be indicated by the time resource assignment of a prior SCI
        according to clause 8.3.1.1 in 3GPP standard specification;
      5> if the number of time and frequency resources that has been maximally
        selected for one or more transmission opportunities from the available
        resources within the intersection is smaller than the selected number of
        HARQ retransmissions:
        6> randomly select the time and frequency resources for the remaining
          transmission opportunities except for the selected resources within the
          intersection from the available resources outside the intersection but left
          in the resources indicated by the physical layer according to clause 8.1.4
          in 3GPP standard specification, according to the amount of selected
          frequency resources, the selected number of HARQ retransmissions and
          the remaining PDB of SL data available in the logical channel(s) allowed
          on the carrier by ensuring the minimum time gap between any two
          selected resources in case that PSFCH is configured for this pool of
          resources and that a retransmission resource can be indicated by the time
          resource assignment of a prior SCI according to clause 8.3.1.1 in 3GPP
          standard specification.
      4> if configured by RRC, sl-InterUE-CoordinationScheme1 enabling reception of
        preferred resource set and non-preferred resource set and when the UE does not
        have own sensing result as specified in clause 8.1.4 in 3GPP standard
        specification and if a preferred resource set is received from a UE; and
      4> if there are available resources left in the received preferred resource set for
        more transmission opportunities:
        5> randomly select the time and frequency resources for one or more
          transmission opportunities from the available resources belonging to the
          received preferred resource set for a MAC PDU to be transmitted to the UE
          providing the preferred resource set, according to the amount of selected
          frequency resources, the selected number of HARQ retransmissions and the
          remaining PDB of SL data available in the logical channel(s) allowed on the
          carrier by ensuring the minimum time gap between any two selected
          resources in case that PSFCH is configured for this pool of resources and
          that a retransmission resource can be indicated by the time resource
          assignment of a prior SCI according to clause 8.3.1.1 in 3GPP standard
          specification.
      4> use the randomly selected resource to select a set of periodic resources spaced
        by the resource reservation interval for transmissions of PSCCH and PSSCH
        corresponding to the number of retransmission opportunities of the MAC PDUs
        determined in 3GPP standard specification;
      4> consider the first set of transmission opportunities as the initial transmission
        opportunities and the other set(s) of transmission opportunities as the
        retransmission opportunities;
      4> consider the sets of initial transmission opportunities and retransmission
        opportunities as the selected sidelink grant;
      4> if configured by RRC, enabling reception of preferred resource set and non-
        preferred resource set and when the UE has own sensing result as specified in
        clause 8.1.4 in 3GPP standard specification and if a non-preferred resource set
        is received from a UE:
        5> indicate the received non-preferred resource set to physical layer.
    3> else:
      4> consider the set as the selected sidelink grant.
    3> use the selected sidelink grant to determine the set of PSCCH durations and the set
      of PSSCH durations according to 3GPP standard specification.
  2>else if SL_RESOURCE_RESELECTION_COUNTER = 0 and when
    SL_RESOURCE_RESELECTION_COUNTER was equal to 1 the MAC entity
    randomly selected, with equal probability, a value in the interval [0, 1] which is less
    than or equal to the probability configured by RRC in sl-ProbResourceKeep:
    3> clear the selected sidelink grant, if available;
    3> randomly select, with equal probability, an integer value in the interval [5, 15] for
      the resource reservation interval higher than or equal to 100ms or in the interval
      $[ 5 \times ⌈ \frac{100}{max ( 20 , {P}_{rsvp \_ TX} )} ⌉ , 15 \times ⌈ \frac{100}{max ( 20 , {P}_{rsvp \_ TX} )} ⌉ ]$
      for the resource reservation interval lower than 100ms and set
      SL_RESOURCE_RESELECTION_COUNTER to the selected value;
    3> reuse the previously selected sidelink grant for the number of transmissions of the
      MAC PDUs determined in 3GPP standard specification with the resource
      reservation interval to determine the set of PSCCH durations and the set of PSSCH
      durations according to 3GPP standard specification.
1> if the MAC entity has selected to create a selected sidelink grant corresponding to
  transmission(s) of a single MAC PDU, and if SL data is available in a logical channel, or
  an SL-CSI reporting is triggered, or a Sidelink DRX Command indication is triggered or
  a Sidelink Inter-UE Coordination Information reporting is triggered, or a Sidelink Inter-
  UE Coordination Request is triggered:
  2> if SL data is available in the logical channel for sidelink discovery:
    3> if sl-BWP-DiscPoolConfig or sl-BWP-DiscPoolConfigCommon is configured
      according to 3GPP standard specification:
      4> select the sl-DiscTxPoolSelected configured in sl-BWP-DiscPoolConfig or sl-
        BWP-DiscPoolConfigCommon for the transmission of sidelink discovery message.
      3> else:
        4> select any pool of resources among the configured pools of resources.
    2> else if SL data for non-discovery is available in the logical channel:
      3> if sl-HARQ-FeedbackEnabled is set to enabled for the logical channel:
        4> select any pool of resources configured with PSFCH resources among the pools
          of resources except the pool(s) in sl-BWP-DiscPoolConfig or sl-BWP-
          DiscPoolConfigCommon, if configured.
      3> else:
        4> select any pool of resources among the pools of resources except the pool(s) in
          sl-BWP-DiscPoolConfig or sl-BWP-DiscPoolConfigCommon, if configured.
    2> else if an SL-CSI reporting or a Sidelink DRX Command or a Sidelink Inter-UE
      Coordination Request or a Sidelink Inter-UE Coordination Information is triggered:
      3> select any pool of resources among the pools of resources except the pool(s) in sl-
        BWP-DiscPoolConfig or sl-BWP-DiscPoolConfigCommon, if configured.
    2> perform the TX resource (re-)selection check on the selected pool of resources as
      specified in clause 5.22.1.2 in 3GPP standard specification;
    2> if the TX resource (re-)selection is triggered as the result of the TX resource (re-)selection
      check:
      3> if one or multiple SL DRX is configured in the destination UE(s) receiving SL-
        SCH data:
        4> indicate to the physical layer SL DRX Active time in the destination UE(s)
          receiving SL-SCH data, as specified in clause 5.28.2 in 3GPP standard
          specification.
      3> select the number of HARQ retransmissions from the allowed numbers, if
        configured by RRC, in sl-MaxTxTransNumPSSCH included in sl-PSSCH-
        TxConfigList and, if configured by RRC, overlapped in sl-
        MaxTxTransNumPSSCH indicated in sl-CBR-PriorityTxConfigList for the highest
        priority of the logical channel(s) allowed on the carrier and the CBR measured by
        lower layers if CBR measurement results are available or the corresponding sl-
        defaultTxConfigIndex configured by RRC if CBR measurement results are not available;
      3> select an amount of frequency resources within the range, if configured by RRC,
        between sl-MinSubChannelNumPSSCH and sl-MaxSubChannelNumPSSCH
        included in sl-PSSCH-TxConfigList and, if configured by RRC, overlapped
        between sl-MinSubChannelNumPSSCH and sl-MaxSubChannelNumPSSCH
        indicated in sl-CBR-PriorityTxConfigList for the highest priority of the logical
        channel(s) allowed on the carrier and the CBR measured by lower layers if CBR
        measurement results are available or the corresponding sl-defaultTxConfigIndex
        configured by RRC if CBR measurement results are not available;
      3> if not configured by RRC, sl-InterUE-CoordinationScheme1 enabling reception of
        preferred resource set and non-preferred resource set:
        4> if transmission based on random selection is configured by upper layers:
          5> randomly select the time and frequency resources for one transmission
            opportunity from the resources pool which occur within the SL DRX
            Active time as specified in clause 5.28.2 in 3GPP standard specification of
            the destination UE selected for indicating to the physical layer the SL DRX
            Active time above, according to the amount of selected frequency
            resources and the remaining PDB of SL data available in the logical
            channel(s) allowed on the carrier, and the latency requirement of the
            triggered SL CSI reporting.
      4> else:
        5> randomly select the time and frequency resources for one transmission
          opportunity from the resources indicated by the physical layer as specified in
          clause 8.1.4 in 3GPP standard specification which occur within the SL DRX
          Active time as specified in clause 5.28.2 in 3GPP standard specification of
          the destination UE selected for indicating to the physical layer the SL DRX
          Active time above, according to the amount of selected frequency resources
          and the remaining PDB of SL data available in the logical channel(s)
          allowed on the carrier, and/or the latency requirement of the triggered SL-
          CSI reporting.
    3> if configured by RRC, sl-InterUE-CoordinationScheme1enabling reception of
      preferred resource set and non-preferred resource set and neither preferred
      resource set nor non-preferred resource set is received from a UE:
      4> if transmission based on random selection is configured by upper layers:
        5> randomly select the time and frequency resources for one transmission
          opportunity from the resources pool, according to the amount of selected
          frequency resources and the remaining PDB of SL data available in the
          logical channel(s) allowed on the carrier, and/or the latency requirement of
          the triggered SL CSI reporting.
      4> else:
        5> randomly select the time and frequency resources for one transmission
          opportunity from the resources indicated by the physical layer as specified in
          clause 8.1.4 in 3GPP standard specification, according to the amount of
          selected frequency resources and the remaining PDB of SL data available in
          the logical channel(s) allowed on the carrier, and/or the latency requirement
          of the triggered SL CSI reporting.
    3> if configured by RRC, sl-InterUE-CoordinationScheme1 enabling reception of
      preferred resource set and non-preferred resource set and when the UE does not
      have own sensing result as specified in clause 8.1.4 in 3GPP standard specification
      and if a preferred resource set is received from a UE:
      4> randomly select the time and frequency resources for one transmission
        opportunity from the resources belonging to the received preferred resource set
        for a MAC PDU to be transmitted to the UE providing the preferred resource
        set, according to the amount of selected frequency resources and the remaining
        PDB of SL data available in the logical channel(s) allowed on the carrier,
        and/or the latency requirement of the triggered SL CSI reporting.
    3> if configured by RRC, sl-InterUE-CoordinationScheme1 enabling reception of
      preferred resource set and non-preferred resource set and when the UE has own
      sensing result as specified in clause 8.1.4 in 3GPP standard specification and if a
      preferred resource set is received from a UE:
      4> randomly select the time and frequency resources for one transmission
        opportunity within the intersection of the received preferred resource set and the
        resources indicated by the physical layer as specified in clause 8.1.4 in 3GPP
        standard specification for a MAC PDU to be transmitted to the UE providing
        the preferred resource set, according to the amount of selected frequency
        resources and the remaining PDB of SL data available in the logical channel(s)
        allowed on the carrier, and/or the latency requirement of the triggered SL CSI
        reporting;
      4> if there are no resources within the intersection that can be selected as the time
        and frequency resources for the one transmission opportunity according to the
        amount of selected frequency resources and the remaining PDB of SL data
        available in the logical channel(s) allowed on the carrier.
          5> randomly select the time and frequency resources for one transmission
            opportunity from the resources indicated by the physical layer as specified
            in clause 8.1.4 in 3GPP standard specification, according to the amount of
            selected frequency resources and the remaining PDB of SL data available
            in the logical channel(s) allowed on the carrier, and/or the latency
            requirement of the triggered SL CSI reporting.
    3> if configured by RRC, sl-InterUE-CoordinationScheme1 enabling reception of
      preferred resource set and non-preferred resource set and when the UE has own
      sensing result as specified in clause 8.1.4 in 3GPP standard specification and if a
      non-preferred resource set is received from a UE:
      4> indicate the received non-preferred resource set to physical layer.
    3> if configured by RRC, sl-InterUE-CoordinationScheme1 enabling reception of
      preferred resource set and non-preferred resource set and when the UE determines
      the resources for Sidelink Inter-UE Coordination Information transmission upon
      explicit request from a UE:
      4> randomly select the time and frequency resources for one transmission
        opportunity from the resources indicated by the physical layer as specified in
        clause 8.1.4 in 3GPP standard specification, according to the amount of selected
        frequency resources, the remaining PDB of SL data available in the logical
        channel(s) allowed on the carrier, and/or the latency requirement of the
        triggered SL-CSI and the latency requirement of the Sidelink Inter-UE
        Coordination Information transmission.
    3> if one or more HARQ retransmissions are selected:
      4> if not configured by RRC, sl-InterUE-CoordinationScheme1 enabling reception
        of preferred resource set and non-preferred resource set:
        5> if transmission based on full sensing or partial sensing is configured by
          upper layers and there are available resources left in the resources indicated
          by the physical layer according to clause 8.1.4 in 3GPP standard
          specification for more transmission opportunities; or
        5> if transmission based on random selection is configured by upper layers and
          there are available resources left in the resources pool for more transmission
          opportunities:
          6> randomly select the time and frequency resources for one or more
            transmission opportunities from the available resources which occur
            within the SL DRX Active time as specified in clause 5.28.2 of the
            destination UE selected for indicating to the physical layer the SL DRX
            Active time above, according to the amount of selected frequency
            resources, the selected number of HARQ retransmissions and the
            remaining PDB of SL data available in the logical channel(s) allowed on
            the carrier, and/or the latency requirement of the triggered SL-CSI by
            ensuring the minimum time gap between any two selected resources in
            case that PSFCH is configured for this pool of resources, and that a
            retransmission resource can be indicated by the time resource assignment
            of a prior SCI according to clause 8.3.1.1 in 3GPP standard specification;
      4> if configured by RRC, sl-InterUE-CoordinationScheme1enabling reception of
        preferred resource set and non-preferred resource set and neither preferred
        resource set nor non-preferred resource set is received from a UE:
        5> if transmission based on sensing is configured by upper layers and there are
          available resources left in the resources indicated by the physical layer
          according to clause 8.1.4 in 3GPP standard specification for more
          transmission opportunities; or
        5> if transmission based on random selection is configured by upper layers and
            there are available resources left in the resource pool for more transmission
            opportunities:
            6> randomly select the time and frequency resources for one or more
              transmission opportunities from the available resources, according to the
              amount of selected frequency resources, the selected number of HARQ
              retransmissions and the remaining PDB of SL data available in the logical
              channel(s) allowed on the carrier, and/or the latency requirement of the
              triggered SL-CSI by ensuring the minimum time gap between any two
              selected resources in case that PSFCH is configured for this pool of
              resources and that a retransmission resource can be indicated by the time
              resource assignment of a prior SCI according to clause 8.3.1.1 in 3GPP
              standard specification.
      4> consider a transmission opportunity which comes first in time as the initial
        transmission opportunity and other transmission opportunities as the
        retransmission opportunities;
      4> consider all the transmission opportunities as the selected sidelink grant;
      4> if configured by RRC, sl-InterUE-CoordinationScheme1 enabling reception of
        preferred resource set and non-preferred resource set and when the UE has own
        sensing result as specified in clause 8.1.4 in 3GPP standard specification and if
        a preferred resource set is received from a UE; and
      4> if there are available resources left in the intersection of the received preferred
        resource set and the resources indicated by the physical layer as specified in
        clause 8.1.4 in 3GPP standard specification for more transmission opportunities:
        5> randomly select the time and frequency resources for one or more
          transmission opportunities from the available resources within the
          intersection for a MAC PDU to be transmitted to the UE providing the
          preferred resource set, according to the amount of selected frequency
          resources, the selected number of HARQ retransmissions and the remaining
          PDB of SL data available in the logical channel(s) allowed on the carrier,
          and/or the latency requirement of the triggered SL-CSI by ensuring the
          minimum time gap between any two selected resources in case that PSFCH
          is configured for this pool of resources and that a retransmission resource
          can be indicated by the time resource assignment of a prior SCI according to
          clause 8.3.1.1 in 3GPP standard specification;
        5> if the number of time and frequency resources that has been maximally
          selected for one or more transmission opportunities from the available
          resources within the intersection is smaller than the selected number of
          HARQ retransmissions:
            6> randomly select the time and frequency resources for the remaining
              transmission opportunities except for the selected resources within the
              intersection from the available resources outside the intersection but left
              in the resources indicated by the physical layer according to clause 8.1.4
              in 3GPP standard specification, according to the amount of selected
              frequency resources, the selected number of HARQ retransmissions and
              the remaining PDB of SL data available in the logical channel(s) allowed
              on the carrier, and/or the latency requirement of the triggered SL-CSI by
              ensuring the minimum time gap between any two selected resources in
              case that PSFCH is configured for this pool of resources and that a
              retransmission resource can be indicated by the time resource assignment
              of a prior SCI according to clause 8.3.1.1 in 3GPP standard specification.
        4> if configured by RRC, sl-InterUE-CoordinationScheme1 enabling reception of
          preferred resource set and non-preferred resource set and when the UE does not
          have own sensing result as specified in clause 8.1.4 in 3GPP standard
          specification and if a preferred resource set is received from a UE; and
        4> if there are available resources left in the received preferred resource set for
          more transmission opportunities:
          5> randomly select the time and frequency resources for one or more
            transmission opportunities from the available resources belonging to the
            received preferred resource set for a MAC PDU to be transmitted to the UE
            providing the preferred resource set, according to the amount of selected
            frequency resources, the selected number of HARQ retransmissions and the
            remaining PDB of SL data available in the logical channel(s) allowed on the
            carrier, and/or the latency requirement of the triggered SL-CSI by ensuring
            the minimum time gap between any two selected resources in case that
            PSFCH is configured for this pool of resources and that a retransmission
            resource can be indicated by the time resource assignment of a prior SCI
            according to clause 8.3.1.1 in 3GPP standard specification.
        4> use the randomly selected resource to select a set of periodic resources spaced
          by the resource reservation interval for transmissions of PSCCH and PSSCH
          corresponding to the number of retransmission opportunities of the MAC PDUs
          determined in 3GPP standard specification;
        4> consider the first set of transmission opportunities as the initial transmission
          opportunities and the other set(s) of transmission opportunities as the
          retransmission opportunities;
        4> consider the sets of initial transmission opportunities and retransmission
          opportunities as the selected sidelink grant.
        4> if configured by RRC, sl-InterUE-CoordinationScheme1enabling reception of
          preferred resource set and non-preferred resource set and when the UE has own
          sensing result as specified in clause 8.1.4 in 3GPP standard specification and if
          a non-preferred resource set is received from a UE:
          5> indicate the received non-preferred resource set to physical layer.
        4> if configured by RRC, sl-InterUE-CoordinationScheme1 enabling reception of
          preferred resource set and non-preferred resource set and when the UE
          determines the resources for Sidelink Inter-UE Coordination Information
          transmission upon explicit request from a UE:
          5> randomly select the time and frequency resources for one transmission
            opportunity from the resources indicated by the physical layer as specified in
            clause 8.1.4 in 3GPP standard specification, according to the amount of
            selected frequency resources, the remaining PDB of SL data available in the
            logical channel(s) allowed on the carrier, and/or the latency requirement of
            the triggered SL-CSI and the latency requirement of the Sidelink Inter-UE
            Coordination Information transmission.
        3> else:
          4> consider the set as the selected sidelink grant.
        3> use the selected sidelink grant to determine PSCCH duration(s) and PSSCH
          duration(s) according to 3GPP standard specification.
NOTE 3A1: If configured by RRC, sl-InterUE-CoordinationScheme1 enabling
          reception of preferred resource set and non-preferred resource set and if multiple
          preferred resource sets are received from the same UE, it is up to UE
          implementation to use one or multiple of them in its resource (re)selection.
NOTE 3B1: If retransmission resource(s) cannot be selected by ensuring that the
        resource(s) can be indicated by the time resource assignment of a prior SCI, how
        to select the time and frequency resources for one or more transmission
        opportunities from the available resources is left for UE implementation by
        ensuring the minimum time gap between any two selected resources in case that
        PSFCH is configured for this pool of resources.
NOTE 3B2: When UE-B receives both a single preferred resource set and a single
        non-preferred resource set from the same UE-A or different UE-As, when UE-B
        has own sensing results, it is up to UE-B implementation to use the preferred
        resource set in its resource (re)selection for transmissions to the UE A providing
        the preferred resource set.
1> if a selected sidelink grant is available for retransmission(s) of a MAC PDU which has
  been positively acknowledged as specified in clause 5.22.1.3.3 in 3GPP standard
  specification:
  2>clear the PSCCH duration(s) and PSSCH duration(s) corresponding to
    retransmission(s) of the MAC PDU from the selected sidelink grant.
NOTE 3C: How the MAC entity determines the remaining PDB of SL data is left to UE
      implementation.
For a selected sidelink grant, the minimum time gap between any two selected resources
comprises:
  a time gap between the end of the last symbol of a PSSCH transmission of the first resource
  and the start of the first symbol of the corresponding PSFCH reception determined by sl-
  MinTimeGapPSFCH and sl-PSFCH-Period for the pool of resources; and
  a time required for PSFCH reception and processing plus sidelink retransmission
  preparation including multiplexing of necessary physical channels and any TX-RX/RX-
  TX switching time.
NOTE: How to determine the time required for PSFCH reception and processing plus
      sidelink retransmission preparation is left to UE implementation.
```

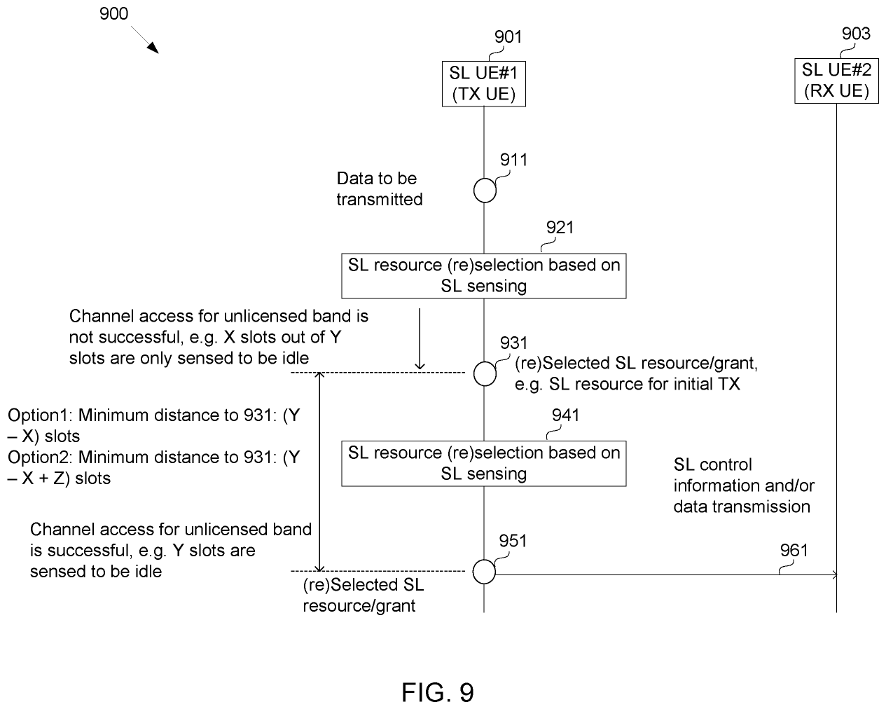

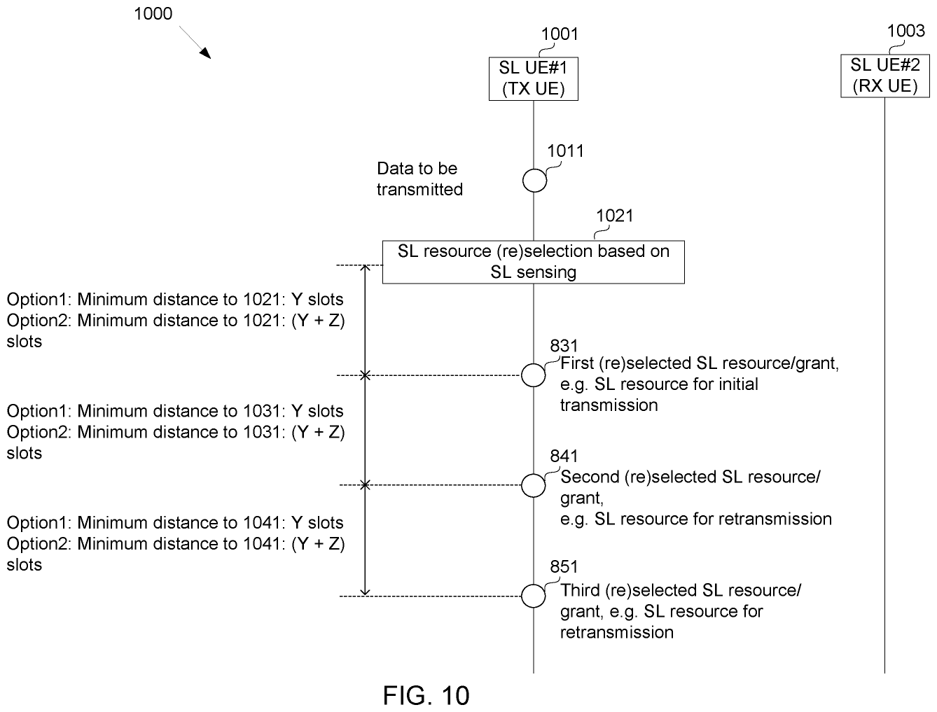

FIG. 9 illustrates a signaling flow 900 for SL resource (re)selection check and SL resource (re)selection according to embodiments of the present disclosure. The signaling flow 900 as may be performed by a UE (e.g., 111-116 as illustrated in FIG. 1) and a base station (e.g., 101-103 as illustrated in FIG. 1). An embodiment of the signaling flow 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

FIG. 9 illustrates an example of an enhanced TX resource (re)selection check and TX resource (re)selection procedures for a SL transmission over unlicensed band. A SL UE #1 901 is configured for a SL transmission and 903 indicates a SL UE #2 that is a peer UE of the SL UE #1 901 for a SL reception. Note that TX resource (re)selection check and TX resource (re)selection procedures are required only for a SL transmission.

When a SL UE #1 901 has a data to be transmitted (911), the SL UE #1 performs resource (re)selection on the selected transmission resource pool (921). Note that SL resource (re)selection is done based on legacy SL sensing. Legacy SL sensing is only for SL resource allocation purpose, and it is different procedure than channel access in unlicensed band that determines whether the UE can access the channel or not (only for channel accessibility purpose).

It may be assumed that the first (re)selected resource (for example, the reserved resource for initial transmission) is the resource indicated by 931, as the result of 921 resource (re)selection. Note multiple resources can be also (re)selected, for example resources for retransmissions and/or other new transmissions as the result of 921 resource (re)selection although it is not shown in the figure. Once 931 SL resource is (re)selected (SL resource is also called as SL selected grant), the SL UE #1 901 may perform the channel access procedure defined in unlicensed band for SL resource 931.

It may be assumed that the channel access is not successful for the SL resource 931, for example only X number of slots out of Y number of slots are sensed to be idle where Y number of slots are required number of slots to be idle for successful channel access for unlicensed band, e.g., Y number of slots are sum of slots for initial CCA and extended CCA in FIG. 8. If the SL resource 931 cannot be used due to a failure of channel access, the SL UE #1's (901) MAC sub-layer triggers SL resource (re)selection (941).

In other words, “if the SL resource 931 cannot be used due to a failure of channel access” is included as new criterion into SL resource (re)selection checking procedure, which eventually triggers SL resource (re)selection. In order the MAC to do that, the SL UE #1's (901) PHY sub-layer can indicate a failure of channel access for the SL resource 931 and/or the remaining number of slots (for example (Y−X) number of slots) to be idle until a success of channel access to the MAC. In SL resource (re)selection in 941, if the SL resource (re)selection was triggered due to a failure of channel access in unlicensed band, the MAC applies a minimum distance from the SL resource 931 (or end of the SL resource 931) to the newly (re)selected SL resources.

In other words, the newly (re)selected SL resource is away from the reserved SL resource 931 (or end of the SL resource 931) by at least a minimum distance. For example, the minimum distance can be defined as the remaining number of slots to be idle until a success of channel access (for example (Y−X) number of slots). In another example, the minimum distance can be defined as {the remaining number of slots+threshold} where the threshold indicates a number of slots (for example (Y−X+Z) number of slots). The threshold (or Z in the example) can be configured by system information or a dedicated RRC message.

In another example, the threshold (or Z in the example) can be pre-configured or fixed. It may be assumed that the (re)selected SL resource is the SL resource indicated by 951, which meets the minimum distance to the SL resource 931 (or end of the SL resource 931). If channel access in an unlicensed band is successful for the SL resource 951, the SL UE #1 901 transmits SL control information and/or data using the SL resource 951 (e.g., 961).

As illustrated in FIG. 9, the minimum distance is described as (Y−X) number of slots or (Y−X+Z) number of slots. In another example, the minimum distance can be defined as Y number of slots or Z number of slots. As illustrated in FIG. 9, new SL resource (re)selection (941) is triggered if the (re)selected SL resource/grant (931) was not used due to a failure of channel access. In another example, new SL resource (re)selection (941) is triggered if the (re)selected SL resource/grant (931) was not used due to a failure of channel access and the next (re)selected SL resource/grant is not away from the previous unused SL resource/grant (931) by the minimum distance.

In another example, the SL resource (951) can be selected as the result of 921 SL resource (re)selection. Note although the figure illustrates the minimum distance after the reserved SL resource (931) as an example, the minimum distance can be also applied before the reserved SL resource (931), e.g. if a SL resource is newly selected before the reserved SL resource (931), the new SL resource needs to be away from the reserved SL resource (931). Also note the minimum distance is applied either in SL resource (re)selection procedure by MAC sub-layer (i.e. when a new SL resource is (re)selected among candidate SL resources in MAC) or in candidate SL resource selection procedure by PHY sub-layer (i.e. when a new candidate SL resource is selected in PHY).

Note that if the next (re)selected SL resource/grant is away from the previous unused SL resource/grant (931) by the minimum distance, although the next (re)selected SL resource/grant is reserved for retransmission it can be used for initial transmission. As another example, in DL and/or UL in unlicensed band case, listen before talk (LBT) failure detection is defined as shown in TABLE 4.

```
TABLE 4
LBT failure detection
5.21.1 General
The lower layer may perform an LBT procedure as described in 3GPP standard specification
according to which a transmission is not performed by lower layers if the channel is identified
as being occupied. When lower layer performs an LBT procedure before a transmission and the
transmission is not performed, an LBT failure indication is sent to the MAC entity from lower
layers. Unless otherwise specified, when LBT procedure is performed for a transmission, actions
as specified in this specification are performed regardless of if an LBT failure indication is
received from lower layers. When LBT is not performed by the lower layers, LBT failure
indication is not received from lower layers.
5.21.2 LBT failure detection and recovery procedure
The MAC entity may be configured by RRC with a consistent LBT failure recovery procedure.
Consistent LBT failure is detected per UL BWP by counting LBT failure indications, for all UL
transmissions, from the lower layers to the MAC entity.
RRC configures the following parameters in the Ibt-FailureRecoveryConfig:
  - lbt-FailureInstanceMaxCount for the consistent LBT failure detection;
  - lbt-FailureDetectionTimer for the consistent LBT failure detection;
The following UE variable is used for the consistent LBT failure detection procedure:
  - LBT_COUNTER (per Serving Cell): counter for LBT failure indication which is initially
      set to 0.
For each activated Serving Cell configured with lbt-FailureRecoveryConfig, the MAC entity
shall:
  1> if LBT failure indication has been received from lower layers:
    2> start or restart the lbt-FailureDetectionTimer;
    2> increment LBT_COUNTER by 1;
    2> if LBT_COUNTER >= lbt-FailureInstanceMaxCount:
      3> trigger consistent LBT failure for the active UL BWP in this Serving Cell;
      3> if this Serving Cell is the SpCell:
          4> if consistent LBT failure has been triggered in all UL BWPs configured with
            PRACH occasions on same carrier in this Serving Cell:
            5> indicate consistent LBT failure to upper layers.
          4> else:
            5> stop any ongoing Random-Access procedure in this Serving Cell;
            5> switch the active UL BWP to a UL BWP, on same carrier in this Serving
              Cell, configured with PRACH occasion and for which consistent LBT failure
              has not been triggered;
            5> initiate a Random-Access Procedure (as specified in clause 5.1.1 in [5]).
  1> if all triggered consistent LBT failures are canceled in this Serving Cell; or
  1> if the lbt-FailureDetectionTimer expires; or
  1> if Ibt-FailureDetectionTimer or Ibt-FailureInstanceMaxCount is reconfigured by upper
    layers:
    2> set LBT_COUNTER to 0.
The MAC entity shall:
  1> if consistent LBT failure has been triggered, and not canceled, in the SpCell; and
  1> if UL-SCH resources are available for a new transmission in the SpCell and these UL-
    SCH resources can accommodate the LBT failure MAC CE plus its subheader as a result
    of logical channel prioritization:
    2> instruct the Multiplexing and Assembly procedure to generate the LBT failure MAC
        CE.
  1> else if consistent LBT failure has been triggered, and not canceled, in at least one SCell:
    2> if UL-SCH resources are available for a new transmission in a Serving Cell for which
        consistent LBT failure has not been triggered and these UL-SCH resources can
        accommodate the LBT failure MAC CE plus its subheader as a result of logical channel
        prioritization:
        3> instruct the Multiplexing and Assembly procedure to generate the LBT failure
          MAC CE.
    2> else:
      3> trigger a Scheduling Request for LBT failure MAC CE.
  1> if a MAC PDU is transmitted and LBT failure indication is not received from lower layers
    and this PDU includes the LBT failure MAC CE:
    2> cancel all the triggered consistent LBT failure(s) in SCell(s) for which consistent LBT
        failure was indicated in the transmitted LBT failure MAC CE.
  1> if consistent LBT failure is triggered and not canceled in the SpCell; and
  1> if the Random Access procedure is considered successfully completed (see clause 5.1 in
    [5]) in the SpCell:
    2> cancel all the triggered consistent LBT failure(s) in the SpCell.
  1> if Ibt-FailureRecoveryConfig is reconfigured by upper layers for a Serving Cell:
    2> cancel all the triggered consistent LBT failure(s) in this Serving Cell.
```

For a SL in an unlicensed band, the similar LBT failure detection and consistent LBT failure declaration are provided. For example, a PHY sub-layer performs LBT procedure for SL bandwidth, PHY indicates LBT failure indication to a MAC sub-layer, and MAC declares consistent LBT failure when the variable (LBT_COUNTER) that is incremented or reset based on the LBT failure indication from PHY and/or a relevant timer (lbt-FailureDetectionTimer expires) is reached to the configured threshold (lbt-FailurelnstanceMaxCount). Then new SL resource (re)selection (941) is triggered when MAC declares consistent LBT failure.

In other words, “when MAC declares consistent LBT failure” is included as new criterion into SL resource (re)selection checking procedure, which eventually triggers SL resource (re)selection. As another example, new SL resource (re)selection (941) is triggered whenever MAC receives LBT failure indication from PHY and MAC has already (re)selected SL resource/grant.

FIG. 10 illustrates a signaling flow 1000 for SL resource (re)selection according to embodiments of the present disclosure. The signaling flow 1000 as may be performed by a UE (e.g., 111-116 as illustrated in FIG. 1) and a base station (e.g., 101-103 as illustrated in FIG. 1). An embodiment of the signaling flow 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

FIG. 10 illustrates another example of an enhanced TX resource (re)selection procedures for a SL transmission over unlicensed band. A SL UE #1 1001 is configured for a SL transmission and a SL UE #2 1003 is a peer UE of the SL UE #1 1001 for a SL reception. Note that TX resource (re)selection check and TX resource (re)selection procedures are required only for a SL transmission. When the SL UE #1 1001 has a data to be transmitted (1011), the SL UE #1 performs resource (re)selection on the selected transmission resource pool (1021).

Note that SL resource (re)selection is done based on legacy SL sensing. Legacy SL sensing is only for SL resource allocation purpose, and it is different procedure than channel access in an unlicensed band that determines whether the UE can access the channel or not (only for channel accessibility purpose). In SL resource (re)selection (1021), the SL UE #1's MAC applies a minimum distance between the initiation of SL resource (re)selection in 1021 and the first SL resource in 1031, and between each consecutive SL resource (for example, between SL resource in 1031 (or end of SL resource in 1031) and SL resource in 1041, and between the SL resource in 1041 (or end of SL resource in 1041) and SL resource in 1051).

In other words, each (re)selected SL resources/grant may be away from the previous (re)selected SL resource/grant (or end of the previous (re)selected SL resource/grant) by at least the minimum distance. For example, the minimum distance can be defined as Y number of slots, where Y number of slots are required number of slots to be idle for successful channel access for unlicensed band, e.g., Y number of slots are sum of slots for initial CCA and extended CCA in FIG. 8.

In another example, the minimum distance can be defined as (Y+Z) number of slots, where Z is a threshold that is configured by system information or dedicated RRC message, pre-configured, or fixed. As another example, the minimum distance can be defined as Z number of slots. With the example of enhanced TX resource (re)selection in FIG. 8, it reduces/removes number of SL resource (re)selection triggered by SL resource (re)selection check from the example as illustrated in FIG. 9.

As illustrated in FIG. 9, the minimum distance is applied when MAC performs SL resource (re)selection among the candidate SL resources indicated by PHY. As another example, PHY applies the minimum distance for all candidate SL resources when PHY selects candidate SL resources. Then since the minimum distance is already applied to all candidate SL resources indicated by PHY, MAC may not need to consider the minimum distance in performing SL resource (re)selection among the candidate SL resources indicated by PHY.

In the descriptions of FIG. 9 and FIG. 10, the minimum distance is described as a number of slots. As another example, the minimum distance can be defined as a number of symbols or sub-frames or SL resources or any other units.

For example, for type 1 DL channel access in NR-U, a gNB performs the following channel access procedures where the time duration spanned by the sensing slots that are sensed to be idle before a downlink transmission(s) is random. It is applicable for transmission(s) initiated by an eNB including PDSCH/PDCCH/EPDCCH or any transmission(s) initiated by a gNB.

A eNB/gNB may transmit a transmission after first sensing the channel to be idle during the sensing slot durations of a defer duration T_{d} and after the counter N is zero in step 4. The counter N is adjusted by sensing the channel for additional sensing slot duration(s) according to the steps as shown TABLE 5.

TABLE 5
Channel access steps

Step 1) set N = Nᵢₙᵢₜ, where Nᵢₙᵢₜ is a random number uniformly
distributed between 0 and CWₚ, and go to step 4;
Step 2) if N > 0 and the eNB/gNB chooses to decrement the counter,
set N = N − 1;
Step 3) sense the channel for an additional sensing slot duration, and
if the additional sensing slot duration is idle, go to step 4; else, go to step
5;
Step 4) if N = 0, stop; else, go to step 2;
Step 5) sense the channel until either a busy sensing slot is detected
within an additional defer duration T_{d} or all the sensing slots of the
additional defer duration T_{d} are detected to be idle; and
Step 6) if the channel is sensed to be idle during all the sensing slot
durations of the additional defer duration T_{d}, go to step 4; else, go to step
5.

If an eNB/gNB has not transmitted a transmission after step 4 in the procedure above, the eNB/gNB may transmit a transmission on the channel if the channel is sensed to be idle at least in a sensing slot duration Tₛₗ when the eNB/gNB is ready to transmit and if the channel has been sensed to be idle during all the sensing slot durations of a defer duration T_{d} immediately before this transmission. If the channel has not been sensed to be idle in a sensing slot duration Tₛₗ when the eNB/gNB first senses the channel after it is ready to transmit or if the channel has been sensed to be not idle during any of the sensing slot durations of a defer duration T_{d} immediately before this intended transmission, the eNB/gNB proceeds to step 1 after sensing the channel to be idle during the sensing slot durations of a defer duration T_{d}.

The defer duration T_{d} comprises a duration T_{f}=16 us immediately followed by mₚ consecutive sensing slot durations Tₛₗ, and T_{f} includes an idle sensing slot duration Tₛₗ at start of T_{f}.

CW_{min,p}≤CWₚ≤CW_{max,p} is the contention window. CWₚ adjustment is described in clause 4.1.4 of 3GPP standard specification.

CW_{min,p} and CW_{max,p} are chosen before step 1 of the procedure above.

mₚ, CW_{min,p}, and CW_{max,p} are based on a channel access priority class p associated with the eNB/gNB transmission, as shown in Table 4.1.1-1 of 3GPP standard specification.

An eNB/gNB may not transmit on a channel for a Channel Occupancy Time that exceeds T_{mcot,p} where the channel access procedures are performed based on a channel access priority class p associated with the eNB/gNB transmissions, as given in Table 4.1.1-1 3GPP standard specification.

If an eNB/gNB transmits discovery burst(s) as described in clause 4.1.2 3GPP standard specification when N>0 in the procedure above, the eNB/gNB may not decrement N during the sensing slot duration(s) overlapping with discovery burst(s).

A gNB may use any channel access priority class for performing the procedures above to transmit transmission(s) including discovery burst(s) satisfying the conditions described in the present disclosure.

A gNB may use a channel access priority class applicable to the unicast user plane data multiplexed in PDSCH for performing the procedures above to transmit transmission(s) including unicast PDSCH with user plane data.

For p=3 and p=4, if the absence of any other technology sharing the channel can be guaranteed on a long term basis (e.g., by level of regulation), T_{mcot,p}=10 ms, otherwise, T_{mcot,p}=8 ms.

In 3GPP, as a new Rel-18 SL feature SL in unlicensed band is under the present discussion. As shown in the existing NR-U channel access, the UE may also perform a channel access procedure for a SL transmission. With the consideration the UE first selects a SL resource autonomously in mode 2 resource allocation before performing channel access procedure for the selected SL resource, if the UE follows legacy SL resource selection procedure that is defined in Rel-16/Rel-17, the selected resource may be abandoned because a time duration between the current time and the selected SL resource may not be long enough to perform channel access procedure. In this embodiment, in order to handle this possible issue, an enhanced resource allocation mechanism with SL measurement result is introduced for the UE that transmits SL data/control in unlicensed band.

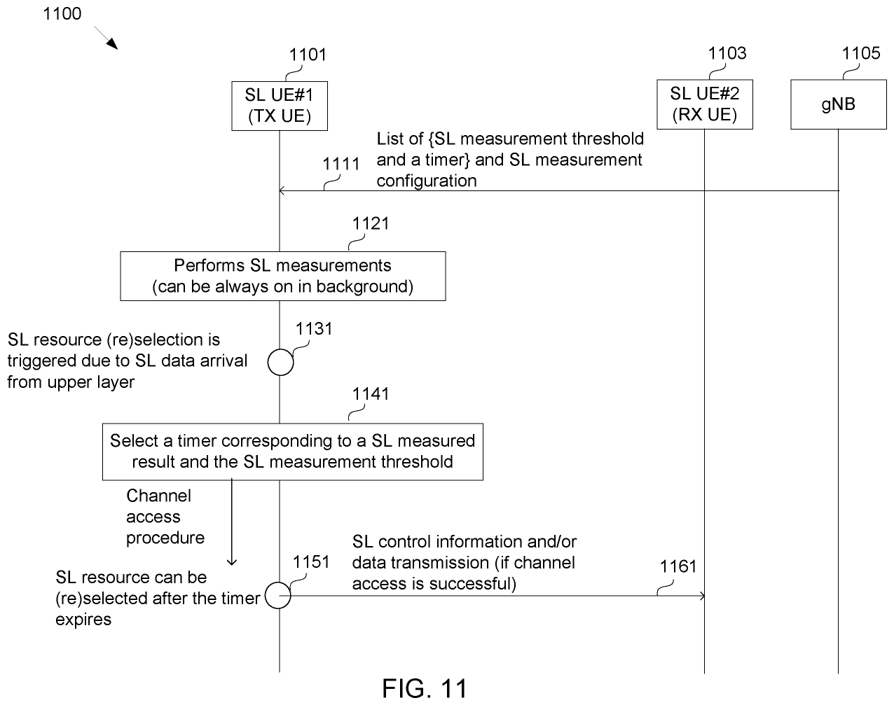

FIG. 11 illustrates a signaling flow 1100 for SL resource allocation using SL measurement according to embodiments of the present disclosure. The signaling flow 1100 as may be performed by a UE (e.g., 111-116 as illustrated in FIG. 1) and a base station (e.g., 101-103 as illustrated in FIG. 1). An embodiment of the signaling flow 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

FIG. 11 describes one example of the embodiment. a SL UE #1 1101 is configured for a SL transmission, a SL UE #2 1103 is a peer UE of the SL UE #1 1101 for SL reception, and 1105 indicates a serving gNB for the SL UE #1 1101. The gNB configures a SL measurement configuration and list of {SL measurement threshold and a timer}. It can be configured by either system information block (SIB) or a UE dedicated RRC signalling (e.g., RRC reconfiguration message). SL measurement quantity can be any of SL RSSI, SL CBR or SL CR as follow. TABLE 6 shows a sidelink received signal strength indicator (SL RSSI) and TABLE 7 shows a SL channel occupancy ratio.

TABLE 6
A SL received signal strength indicator (SL RSSI)

| | |
|---|---|
| Definition | Sidelink Received Signal Strength Indicator (SL RSSI) is defined as the linear |
| | average of the total received power (in [W]) observed in the configured sub- |
| | channel in OFDM symbols of a slot configured for PSCCH and PSSCH, |
| | starting from the 2^{nd} OFDM symbol. |
| | For frequency range 1, the reference point for the SL RSSI may be the antenna |
| | connector of the UE. For frequency range 2, SL RSSI may be measured based |
| | on the combined signal from antenna elements corresponding to a given |
| | receiver branch. For frequency range 1 and 2, if receiver diversity is in use by |
| | the UE, the reported SL RSSI value may not be lower than the corresponding |
| | SL RSSI of any of the individual receiver branches. |
| Applicable for | RRC_IDLE intra-frequency, |
| | RRC_IDLE inter-frequency, |
| | RRC_CONNECTED intra-frequency, |
| | RRC_CONNECTED inter-frequency |

TABLE 7
A SL channel occupancy ratio (SL CR)

| | |
|---|---|
| Definition | Sidelink Channel Occupancy Ratio (SL CR) evaluated at |
| | slot n is defined as the total number of sub-channels used |
| | for its transmissions in slots [n − a, n − 1] and granted in |
| | slots [n, n + b] divided by the total number of configured |
| | sub- channels in the transmission pool over [n − a, n + b]. |
| Applicable | RRC_IDLE intra-frequency, |
| for | RRC_IDLE inter-frequency, |
| | RRC_CONNECTED intra-frequency, |
| | RRC_CONNECTED inter-frequency |

It is noted that a is a positive integer and b is 0 or a positive integer; a and b are determined by UE implementation with a+b+1=1000 or 1000·2^{μ} slots, according to higher layer parameter sl-TimeWindowSizeCR, b<(a+b+1)/2, and n+b may not exceed the last transmission opportunity of the grant for the current transmission.

It is noted that SL CR is evaluated for each (re)transmission.

It is noted that, in evaluating SL CR, the UE may assume the transmission parameter used at slot n is reused according to the existing grant(s) in slot [n+1, n+b] without packet dropping.

It is noted that the slot index is based on physical slot index.

It is noted that SL CR can be computed per priority level.

It is noted that a resource is considered granted if it is a member of a selected sidelink grant defined in 3GPP standard specification. TABLE 8 shows a SL channel busy ratio (SL CBR).

TABLE 8
A SL channel busy ratio (SL CBR)

| | |
|---|---|
| Definition | SL Channel Busy Ratio (SL CBR) measured in slot n is defined as the portion |
| | of sub-channels in the resource pool whose SL RSSI measured by the UE |
| | exceed a (pre-)configured threshold sensed over a CBR measurement window |
| | [n − a, n − 1], wherein a is equal to 100 or 100 · 2^{μ} slots, according to higher layer |
| | parameter sl-Time WindowSizeCBR. When UE is configured to perform partial |
| | sensing by higher layers (including when SL DRX is configured), SL RSSI is |
| | measured in slots where the UE performs partial sensing and where the UE |
| | performs PSCCH/PSSCH reception within the CBR measurement window. The |
| | calculation of SL CBR is limited within the slots for which the SL RSSI is |
| | measured. If the number of SL RSSI measurement slots within the CBR |
| | measurement window is below a (pre-)configured threshold, a (pre-)configured |
| | SL CBR value is used. |
| Applicable for | RRC_IDLE intra-frequency, |
| | RRC_IDLE inter-frequency, |
| | RRC_CONNECTED intra-frequency, |
| | RRC_CONNECTED inter-frequency |

It is noted that the slot index is based on physical slot index.

It is noted that 1111 can be also preconfigured by other network entity or other means. Once SL UE #1 is configured for 1111, the UE performs the corresponding SL measurement (1121). The SL measurement can be performed in background regardless of the need of channel access procedure in unlicensed band. It may be assumed that the SL measurement quantity is SL CBR. 1131 indicates the time when the SL UE #1 triggers SL resource (re)selection due to new SL data arrival from the upper layer. Then the SL UE #1 selects the corresponding timer based on SL CBR measured result and its corresponding to a SL measurement threshold.

For example, if the latest SL CBR measured result (or the SL CBR measured result at 1131) is between a SL measurement threshold #1 (as lower boundary) and a SL measurement threshold #2 (as upper boundary), the SL UE #1 selects the timer that is associated with the SL measurement threshold #2 (when the timer selection is defined according to the upper boundary threshold.

In another example, it may be a SL measurement threshold #1 if the timer selection is defined according to the lower boundary threshold). The SL UE #1 knows when the timer expires in advance with the assumption the timer is started at a specified time, for example when the timer is started at 1131. The SL UE #1 can only (re)select SL resource that is located in time-domain after the timer expires. It may be assumed that the UE (re)selects SL resource at 1151 that is located in time-domain after the timer expires. The SL UE #1 performs channel access procedure for 1151 (re)selected SL resource. If the channel access procedure is successful, the SL UE #1 can transmit SL control information and/or SL data by using the SL resource.

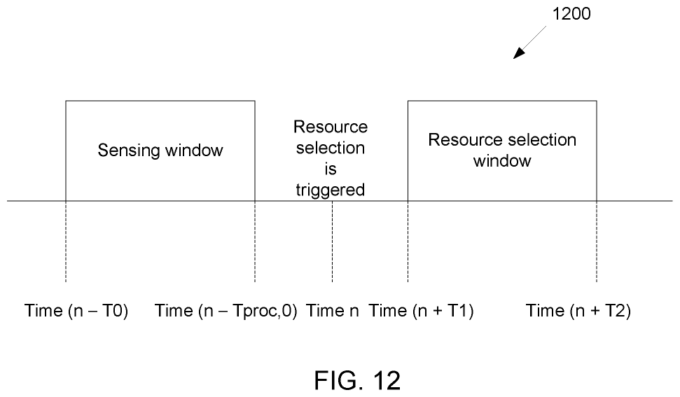

FIG. 12 illustrates an example of legacy time relations for candidate SL resources in a PHY sub-layer 1200 according to embodiments of the present disclosure. An embodiment of the legacy time relations for candidate SL resources in the PHY sub-layer 1200 shown in FIG. 12 is for illustration only.

In FIG. 12, it is assumed that the SL UE #1 applies list of {SL measurement threshold and a timer} in a MAC sub-layer when the MAC performs SL resource (re)selection out of all candidate SL resources that indicated by a PHY sub-layer. In another example, the provided UE behaviour according to the list of {SL measurement threshold and a timer} can be applied to the PHY sub-layer when the PHY performs selection of candidate SL resources.

FIG. 12 describes current time relations for candidate SL resources in PHY (in Rel-16 and/or Rel-17 SL). It is assumed that the PHY triggers candidate SL resource selection at time n. The PHY already performed channel sensing during the sensing window in order to find out observed available SL resources. Channel sensing is actually performed in advance than time n (for example, sensing window is from time (n−T0) to time (n−Tproc,0)). Then with using the output of the channel sensing, the PHY selects the candidate SL resource(s) for transmission among the observed available SL channels during the resource selection window.

For example, resource selection window is from time (n+T1) to time (n+T2). If the provided UE behavior according to the list of {SL measurement threshold and a timer} is applied to the PHY, the timer can be started either at Time (n−T0), Time (n−Tproc, 0) or time n. It may be assumed that the timer is started at time n, then the resource selection window is started after the timer expires. For example, the start of resource selection window will be the time whatever between {time (n+T1) and time (n+the timer duration)} comes first.

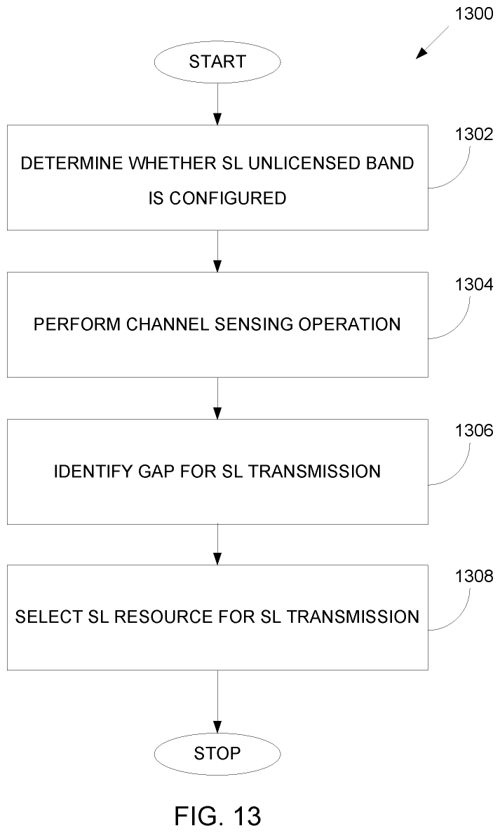

FIG. 13 illustrates a flowchart of a method 1300 for an UE operation for SL resource selection and reselection for a SL transmission. The method 1300 as may be performed by a UE (e.g., 111-116 as illustrated in FIG. 1). An embodiment of the method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

As illustrated in FIG. 13, the method 1300 begins at step 1302. In step 1302, a UE determines whether a SL unlicensed band is configured for a SL transmission.

In step 1304, the UE performs a channel sensing operation to determine whether a channel is available for channel access on the SL unlicensed band.

In step 1306, the UE identifies a gap, based on a time duration for the channel sensing operation, for the SL transmission.

In one embodiment, the gap is identified, and the SL resource is selected during a candidate SL resource selection procedure in a PHY layer or in a SL resource selection and reselection procedure in a medium access control MAC layer.

In one embodiment, the gap is identified in a first number of SL slots, a first number of SL symbols, or a first number of SL resources that is required to be sensed as an idle state for the time duration.

In one embodiment, the first number of SL slots, the first number of SL symbols, or the first number of SL resources is associated with a SL channel access priority class or a result of a previous channel sensing operation.

In step 1308, the UE selects, based on the identified gap, a SL resource for the SL transmission, wherein the SL resource is located outside of the identified gap from a previously reserved SL resource.

In one embodiment, the UE identifies the gap in: a second number of SL slots that is equal to a difference between a number of slots that is required to be sensed as an idle state for the time duration and a previous number of slots that was sensed as the idle state in a previous channel sensing operation based on a LBT operation for the previously reserved SL resource; a second number of SL symbols that is equal to a difference between a number of symbols that is required to be sensed as the idle state for the time duration and a previous number of symbols that was sensed as the idle state in the previous channel sensing operation based on the LBT operation for the previously reserved SL recourse; or a second number of SL resources that is equal to a difference between a number of resources that is required to be sensed as the idle state for the time duration and a previous number of resources that was sensed as the idle state in the previous channel sensing operation based on the LBT operation for the previously reserved SL recourse.

In one embodiment, the UE identifies the gap in a third number of SL slots, a third number of SL symbols, or a third number of SL resources, wherein the third number of SL slots, the third number of SL symbols, or the third number of SL resources is: configured by system information, or a UE dedicated RRC message, or pre-configured or based on a pre-determined value.

In one embodiment, the UE measures a channel busy ratio on the SL unlicensed band and identifies the gap in a fourth number of SL slots, a fourth number of SL symbols, or a fourth number of SL resources based on the measured channel busy ratio.

In one embodiment, the fourth number of SL slots, the fourth number of SL symbols, or the fourth number of SL resources is: configured by system information, or a UE dedicated RRC message, or pre-configured or based on pre-determined value; and the gap is identified based on a comparison of the measured channel busy ratio with a threshold.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver; and
a processor operably coupled to the transceiver, the processor configured to:
determine whether a sidelink (SL) unlicensed band is configured for a SL transmission,
perform a channel sensing operation to determine whether a channel is available for channel access on the SL unlicensed band,
identify a gap, based on a time duration for the channel sensing operation, for the SL transmission, and
select, based on the identified gap, a SL resource for the SL transmission, wherein the SL resource is located outside of the identified gap from a previously reserved SL resource.

2. The UE of claim 1, wherein the gap is identified and the SL resource is selected during a candidate SL resource selection procedure in a physical (PHY) layer or in a SL resource selection and reselection procedure in a medium access control (MAC) layer.

3. The UE of claim 1, wherein the gap is identified in a first number of SL slots, a first number of SL symbols, or a first number of SL resources that is required to be sensed as an idle state for the time duration.

4. The UE of claim 3, wherein the first number of SL slots, the first number of SL symbols, or the first number of SL resources is associated with a SL channel access priority class or a result of a previous channel sensing operation.

5. The UE of claim 1, wherein the processor is further configured to identify the gap based on:
a second number of SL slots that is equal to a difference between a number of slots that is required to be sensed as an idle state for the time duration and a previous number of slots that was sensed as the idle state in a previous channel sensing operation based on a listen-before-talk (LBT) operation for the previously reserved SL resource;
a second number of SL symbols that is equal to a difference between a number of symbols that is required to be sensed as the idle state for the time duration and a previous number of symbols that was sensed as the idle state in the previous channel sensing operation based on the LBT operation for the previously reserved SL recourse; or
a second number of SL resources that is equal to a difference between a number of resources that is required to be sensed as the idle state for the time duration and a previous number of resources that was sensed as the idle state in the previous channel sensing operation based on the LBT operation for the previously reserved SL recourse.

6. The UE of claim 1, wherein:
the processor is further configured to identify the gap in a third number of SL slots, a third number of SL symbols, or a third number of SL resources, and
the third number of SL slots, the third number of SL symbols, or the third number of SL resources is:
configured by system information, or a UE dedicated RRC message, or
pre-configured or based on a pre-determined value.

7. The UE of claim 1, wherein the processor is further configured to:
measure a channel busy ratio on the SL unlicensed band; and
identify the gap in a fourth number of SL slots, a fourth number of SL symbols, or a fourth number of SL resources based on the measured channel busy ratio.

8. The UE of claim 7, wherein:
the fourth number of SL slots, the fourth number of SL symbols, or the fourth number of SL resources is:
configured by system information, or a UE dedicated RRC message, or
pre-configured or based on pre-determined value; and
the gap is identified based on a comparison of the measured channel busy ratio with a threshold.

9. A user equipment (UE) comprising:
a transceiver; and
a processor operably coupled to the transceiver, the processor configured to:
determine whether a sidelink (SL) unlicensed band is configured for SL transmissions,
determine, based on a determination that the SL unlicensed band is configured, whether a physical (PHY) layer indication is triggered, wherein the PHY layer indication indicates a failure of a channel access operation for a previous SL transmission, and
enable a medium access control (MAC) layer to trigger a SL resource selection or reselection procedure based on a determination that the PHY layer indication is triggered.

10. The UE of claim 9, wherein the PHY layer and the MAC layer are functional entities located in the UE.

11. A method of a user equipment (UE), the method comprising:
determining whether a sidelink (SL) unlicensed band is configured for a SL transmission;
performing a channel sensing operation to determine whether a channel is available for channel access on the SL unlicensed band;
identifying a gap, based on a time duration for the channel sensing operation, for the SL transmission; and
selecting, based on the identified gap, a SL resource for the SL transmission, wherein the SL resource is located outside of the identified gap from a previously reserved SL resource.

12. The method of claim 11, wherein the gap is identified and the SL resource is selected during a candidate SL resource selection procedure in a physical (PHY) layer or in a SL resource selection and reselection procedure in a medium access control (MAC) layer.

13. The method of claim 11, wherein the gap is identified in a first number of SL slots, a first number of SL symbols, or a first number of SL resources that is required to be sensed as an idle state for the time duration.

14. The method of claim 13, wherein the first number of SL slots, the first number of SL symbols, or the first number of SL resources is associated with a SL channel access priority class or a result of a previous channel sensing operation.

15. The method of claim 11, further comprising identifying the gap based on:
a second number of SL slots that is equal to a difference between a number of slots that is required to be sensed as an idle state for the time duration and a previous number of slots that was sensed as the idle state in a previous channel sensing operation based on a listen-before-talk (LBT) operation for the previously reserved SL resource;
a second number of SL symbols that is equal to a difference between a number of symbols that is required to be sensed as the idle state for the time duration and a previous number of symbols that was sensed as the idle state in the previous channel sensing operation based on the LBT operation for the previously reserved SL recourse; or
a second number of SL resources that is equal to a difference between a number of resources that is required to be sensed as the idle state for the time duration and a previous number of resources that was sensed as the idle state in the previous channel sensing operation based on the LBT operation for the previously reserved SL recourse.

16. The method of claim 11, further comprising identifying the gap in a third number of SL slots, a third number of SL symbols, or a third number of SL resources,
wherein the third number of SL slots, the third number of SL symbols, or the third number of SL resources is:
configured by system information, or a UE dedicated RRC message, or
pre-configured or based on a pre-determined value.

17. The method of claim 11, further comprising:
measuring a channel busy ratio on the SL unlicensed band; and
identifying the gap in a fourth number of SL slots, a fourth number of SL symbols, or a fourth number of SL resources based on the measured channel busy ratio.

18. The method of claim 17, wherein:
the fourth number of SL slots, the fourth number of SL symbols, or the fourth number of SL resources is:
configured by system information, or a UE dedicated RRC message, or
pre-configured or based on pre-determined value; and
the gap is identified based on a comparison of the measured channel busy ratio with a threshold.
